(19) United States
(12) Patent Application Publication
(10) Pub. No.: US 2015/0211564 A1
(43) Pub. Date: Jul. 30, 2015

(54) NAIL-CLAMPING PLASTIC BAR ON NAIL GUN

(71) Applicant: Man Ting Yeung, Kowloon (HK)

(72) Inventor: Man Ting Yeung, Kowloon (HK)

(21) Appl. No.: 14/576,239

(22) Filed: Dec. 19, 2014

(30) Foreign Application Priority Data
Jan. 25, 2014 (CN) 201420049543.8

(51) Int. Cl. F16B 15/08

(52) U.S. Cl. CPC F16B 15/08

(57) ABSTRACT

A nail-clamping plastic bar on a nail gun, which consists of two or more clamping units connected in series; each clamping unit comprises: at least two clamping rods and connecting strips; each connecting strip is used to connect two adjacent clamping rods; the clamping rods form a ring body for the nail rod; and two adjacent clamping units are connected through one or more connecting ribs. The plastic bar is designed to be formed by multiple clamping units connected in series, and can be bent to fit nail casing of different shapes. The chamfers at the two ends of each clamping rod can be molded in half; the connecting strips can also be molded in half without any sliding block, hence the die space can be fully utilized, and generated the maximum cavities for the die. Therefore, the die efficiency is greatly improved and the die cost is reduced.

### CROSS REFERENCE OF RELATED APPLICATION

The present invention claims priority under 35 U.S.C. 119(a-d) to CN, filed.

### BACKGROUND OF THE PRESENT INVENTION

1. Field of Invention

The present invention relates to the field of nailing instruments, in particular to a nail-clamping plastic bar on a nail gun.

2. Description of Related Arts

Competition among nailing instruments has become intense day by day. On condition of keeping the quality and performance of nails on a bar, how to reduce the cost of the bar becomes the permanent pursuit of the enterprise. Traditional plastic bars can be split to form dies in the radial of the plastic bars, the holes for the fixing nails are formed by designing a sliding block to extracting the core. In order to reach the effect where the nails can be inserted from both ends of the plastic bar in all directions, both ends of the plastic bar require a sliding block for extracting the core and then chamfer holes where the nails can be installed from both ends can be formed. Moreover, the traditional plastic bars have poor flexibility, and usually can only be applied to the traditional vertical nail casings, and without special design, the connecting ribs between the holes tend to leave residues in the nail casing when breaking and therefore make nails clamped.

### SUMMARY OF THE PRESENT INVENTION

The objective of the present invention is to provide a nail-clamping plastic bar on a nail gun, which can be split to form dies along the axial direction of each clamping unit, without a sliding block. Then, the die of the same volume can generate more bar cavities, so the die efficiency is improved, the die cost is reduced, and the production efficiency is enhanced. To realize the above objective, the present invention provides a nail-clamping plastic bar for a nail gun. The plastic bar is formed by two or more connected clamping units; each clamping unit comprises at least two clamping rods and as many connecting strips as the clamping rods; each connecting strip is used to connect two adjacent clamping rods together; after connection, the connecting strips and the clamping rods form a ring body capable of being sleeved on the rod of a nail; and two adjacent clamping units are connected through one or more connecting ribs.

Furthermore, each clamping rod has two ends with chamfers on the inner sides, and those chamfers are consistent with those at the junction of the nail rod and a nail cap, so the nails can be firmly clamped in the clamping unit, thus greatly improving the stability and output force of the nail shooting.

The number of the clamping rods and connecting strips is four each; each connecting strip is used to connect two adjacent clamping rods; after the four clamping rods are connected together through four connecting strips, the four connecting strips are enclosed to form a ring body capable of being sleeved on the nail rod, and the four clamping rods are enclosed to form a space for restraining the nail rod.

One or more connecting ribs are disposed between two adjacent ring bodies; the bar formed by two or more clamping units can be bent randomly and the outer surfaces of the connecting ribs are notched, which are breaking points for adjacent ring bodies.

Each clamping unit is integrally molded by at least two clamping rods and as many connecting strips as the clamping rods; and the bar is integrally molded by two or more clamping units and the connecting ribs that connect two adjacent clamping units. The present invention has the following beneficial technical effects: According to the design, the plastic bar is formed by multiple clamping units, can bend and therefore can be conveniently split in the axial direction of each clamping unit to make dies; the two chambers of the clamping rod, the outer wall, and inner wall of the clamping rod can be respectively molded in half or part in the front and rear dies, the connecting rib can also be formed molded in half or part in the front and rear dies without any sliding block, so the die space can be fully utilized, and the die of the same volume can generate more bar-shaped cavities to greatly improve the die efficiency, reduce die cost, and enhance production; and, the plastic bar is highly flexible and can fit nail casings of different shapes such as straight or arc shape. Except the end face, the surfaces of the connecting rib are provided with notches to facilitate disconnection between the previous clamping unit and the rear clamping unit during nail shooting. In such circumstances, the fracture surface of the connecting rib is flat; no residues remain in the nail casing to make the nail stuck; and moreover, the bar formed by multiple clamping units bends and deforms easily.

### BRIEF DESCRIPTION OF THE DRAWINGS

FIG. 1 is a front view of the present invention.

FIG. 2 is a stereogram of the present invention.

FIG. 3 is a stereogram of the nail of the present invention.

FIG. 4 is a view of the first embodiment of the present invention combined with the nail.

FIG. 5 is a view of the second embodiment of the present invention combined with the present invention.

FIG. 6 is a view of the embodiment of the present invention on the nail gun.

### DETAILED DESCRIPTION OF THE PREFERRED EMBODIMENT

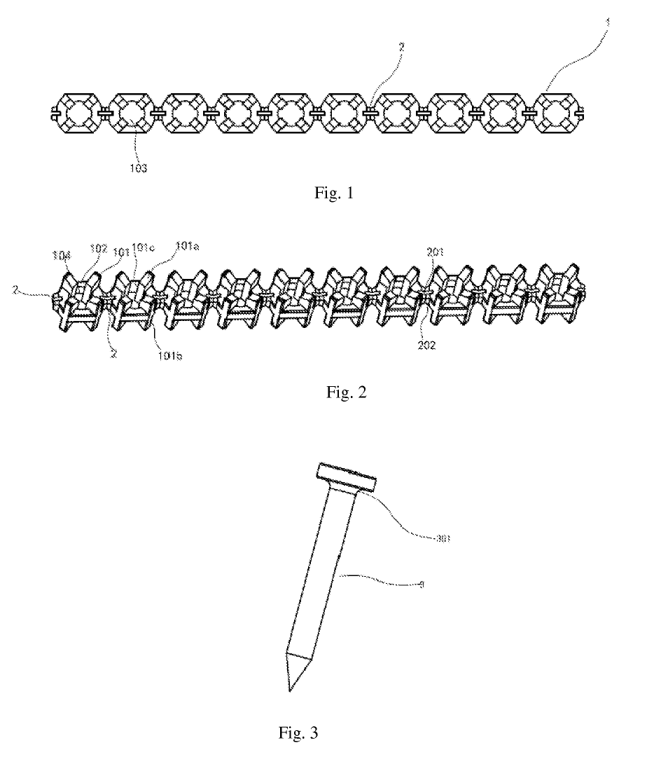

Referring to FIGS. 1 and 2, a nail-clamping plastic bar on a nail gun is formed by two or more connected clamping units 1. In this embodiment, the clamping unit comprises: four clamping rods 101 and four connecting strips 102; each connecting strip 102 is used to connect two adjacent clamping rods 101; after the four clamping rods 101 are connected with four connecting strips 102, the four connecting strips 102 are enclosed and combined with a part of the clamping rod 101 to form a ring body 103 capable of being sleeved on the nail rod; and the four clamping rods 101 are enclosed to form a space 104 for restraining the nail rod.

The number of the clamping rods 101 may be two or more; when two connecting strips 102 connect the two clamping rods together, the ring body sleeved on the nail rod and the space for restraining the nail rod can also be formed. Two adjacent clamping units 1 are connected through one or more deformable connecting ribs 2. In this embodiment, the two adjacent clamping units 1 are connected through a deformable connecting rib 2, and the connecting rib 2 is made from plastic available on the market, and the entire plastic bar is integrally formed and deformable.

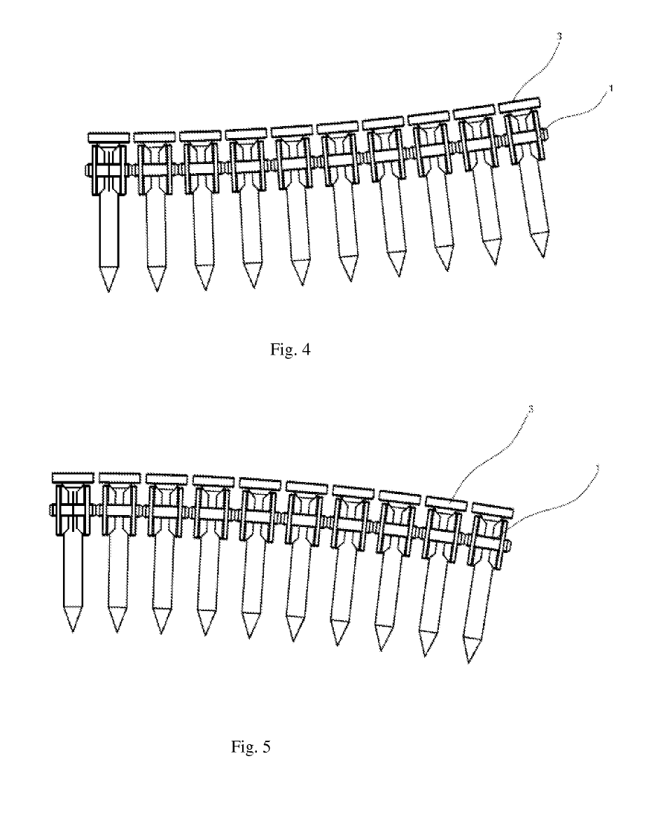

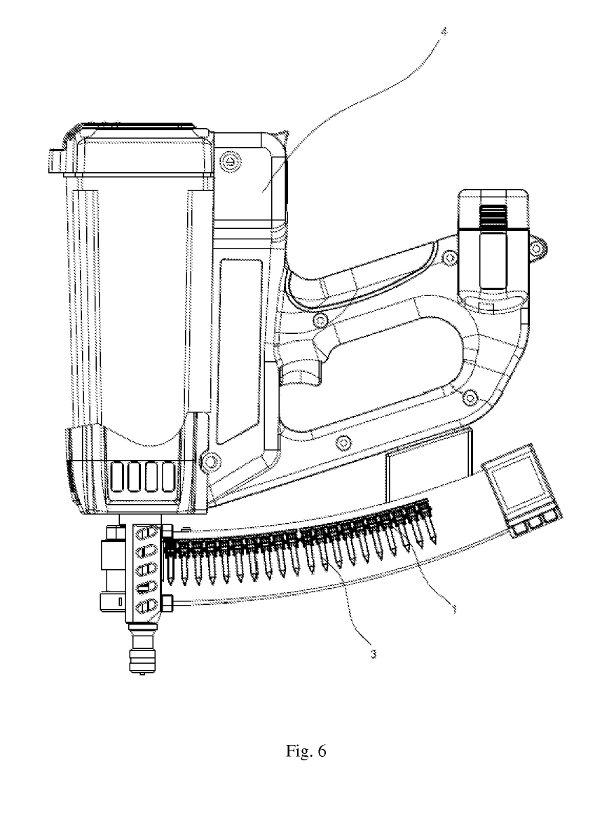

The two ends of each clamping rod 101 are provided with chamfers 101a on the inner sides. Those chamfers are consistent with the chamfer 301 at the junction of the rod of nail 3 and a nail cap, as shown in FIG. 3, so the nail can be stably clamped in the clamping unit, thus greatly improving the stability and output force of the nail shooting. As shown in FIGS. 1, 2, 4 and 5, after the nail 3 is combined with the clamping unit 1 on the plastic bar, the surface formed by nail caps of multiple nails may be a plane or a curved surface, which means that the bar can be bent rationally. As shown in FIGS. 4, 5 and 6, the plastic bar is equipped with the nail 3 first and then installed at the nail gun 4. The plastic bar is bendable and flexible and can fit nail casings of different shapes such as vertical shape and arc shape; in addition, after the plastic bar is installed on the nail gun, the nail casing or guide rail of the nail gun 3 will not be damaged in the case of construction in corners, so the application scope of the tool is enlarged, and the service life of the tool prolonged.

As shown in FIG. 2, the plastic bar is designed to be formed by multiple clamping units 1, and every two adjacent clamping units 1 are connected through one or more deformable connecting ribs 2. In this embodiment, the two adjacent clamping units 1 are connected with one deformable connecting rib 1 such that the bar can be split to make dies in the radial direction of each clamping unit 1; the two chamfers 101a of the clamping rod 101, the outer wall 101b and inner wall 101c of the clamping rod can be respectively halved in the front and rear dies; the connecting strip 102 can also form halves in the front and rear dies without any sliding block, so the die space can be fully utilized, and the die of the same volume can generate more bar-shaped cavities. Therefore the die efficiency is greatly improved and the die cost is reduced.

Each surface of the connecting rib is provided with a notch 202 such that the previous clamping unit and the rear clamping unit are disconnected during nailing. In such circumstances, the fracture surface of the connecting rib is flat; no residues remain in the nail box to make the nail stuck; and moreover, the bar formed by multiple clamping units bends and deforms easily.

The embodiment depicts the present invention. Those ordinarily skilled in this field know that the present invention has many modifications and changes without departing from the spirit of the present invention, which shall fall within the protective scope of the present invention.

What is claimed is:

1. A nail-clamping plastic bar on a nail gun, formed by two or more connected clamping units, characterized in that each clamping unit comprises: at least two clamping rods and as many connecting strips as the clamping rods; each connecting strip is used to connect two adjacent clamping rods together; the two connected form a ring body capable of being sleeved on the rod of a nail; and two adjacent clamping units are connected through one or more connecting ribs.

2. The nail-clamping plastic bar on a nail gun according to claim 1, characterized in that each clamping rod has two ends with chamfers on the inner sides, and the chamfers are consistent with those at the junction of the nail rod and nail cap of a nail.

3. The nail-clamping plastic bar on a nail gun according to claim 1, characterized in that the number of clamping rods and connecting strips is four each; each connecting strip is used to connect two adjacent clamping rods; after the four clamping rods are connected together through four connecting strips, the four connecting strips are enclosed to form a ring body capable of being sleeved on the nail rod, and the four clamping rods are enclosed to form a space for restraining the nail rod.

4. The nail-clamping plastic bar on a nail gun according to claim 1, characterized in that one or more connecting ribs are disposed between two adjacent ring bodies; the bar formed by two or more clamping units can be bent randomly and the outer surfaces of the connecting ribs are notched, which are breaking points for adjacent ring bodies.

5. The nail-clamping plastic bar on a nail gun according to claim 1, characterized in that each clamping unit is integrally molded by at least two clamping rods and as many connecting strips as the clamping rods; and the bar is integrally molded by two or more clamping units and the connecting strips that connect two adjacent clamping units.
